(19) United States
(12) Patent Application Publication
(10) Pub. No.: US 2021/0009433 A1
(43) Pub. Date: Jan. 14, 2021

(54) METHOD FOR EXTRACTING A MINERAL FROM BIOTITES

(71) Applicants: BRGM, Orleans Cedex 2 (FR); TOTAL S.A., Courbevoie (FR)

(72) Inventors: Robert WYNS, Beaugency (FR); Julien BAPTISTE, La Ferté-Saint-Aubin (FR); Jéromine DURON, La Ferté-Saint-Aubin (FR); Jean-Yves ROIG, Olivet (FR); Sébastien MONTECH, La Ferté St Cyr (FR)

(21) Appl. No.: 16/923,203

(22) Filed: Jul. 8, 2020

(30) Foreign Application Priority Data
Jul. 8, 2019 (FR) 1907628

(51) Int. Cl. C01B 33/26

(52) U.S. Cl. CPC C01B 33/26

(57) ABSTRACT

A method for extracting a mineral contained in biotite. The method includes a step of freezing the biotite, followed by a step of thawing the biotite. A method for characterizing a paleoalteration, in which at least one mineral is studied that is contained in cleavages of biotite extracted from a felsic rock that is at least partially altered.

### FIELD OF THE INVENTION

The invention relates to the extraction of minerals contained in biotite, in particular potassium feldspars. It also relates to the characterization of a paleoalteration, and more particularly of a felsic rock containing biotite, in particular a granitoid.

### BACKGROUND OF THE INVENTION

The alteration of metamorphic or plutonic rocks, whether hydrothermal or supergene, results in particular in the early transformation of biotite into chlorite or vermiculite, depending on the temperatures of the fluids present. In addition, the alteration of biotite to chlorite is very often accompanied by the crystallization of potassium feldspar, according to the following reaction:

biotite+quartz+H2O->chlorite+goethite+potassium feldspar

These potassium feldspars could correspond to adularias, minerals which are potassium feldspars crystallizing at low temperature (around 100° C.). Newly formed adularias are commonly seen in altered felsic rocks such as granites. These adularia grains are small (around 30 μm to 300 μm) and frequently precipitate in the cleavage of biotite in the process of chloritization.

Chloritized biotite can also contain quartz, plagioclase and prehnite crystals in their cleavages.

The study of potassium feldspars resulting from the alteration of biotite makes it possible to characterize, and in particular to date, the alteration of altered felsic grainy rocks rich in biotite.

### SUMMARY OF THE INVENTION

The object of the invention is to provide a method for separating minerals present in altered biotite (chloritized biotite in particular) present in rocks undergoing alteration, with a view to the characterization of these minerals and the dating of potassium feldspars.

To that end, the invention relates to a method for extracting a mineral contained in biotite, the method comprising a step of freezing the biotite, followed by a step of thawing the biotite.

Thanks to a method they have developed, the inventors propose to isolate these minerals, which then makes it possible to characterize them, and also to characterize the paleoalteration of the rocks from which they come, by studying the potassium feldspars. This extraction method is particularly interesting because it makes it possible to extract minerals which are in the form of very small crystals (30 μm to 300 μm) and are therefore easy to handle.

More particularly, the mineral is contained in the cleavages of biotite.

Advantageously, the thawing of the biotite is a lyophilization. Lyophilization refers to the desiccation of previously frozen biotite by sublimation of water. Surprisingly, the inventors have shown that lyophilization makes it possible to open the flakes of biotite.

Preferably, the mineral is chosen from the following minerals: potassium feldspar, quartz, plagioclase, and prehnite.

It is particularly advantageous to extract potassium feldspars because they contain potassium, which is a datable element by the Ar/Ar dating method.

Advantageously, the biotite is brought into contact with water, and preferably demineralized water, prior to the freezing and thawing steps. It is kept in contact with water during the freezing stage and at least part of the thawing stage. The biotite can be kept in contact with water throughout the thawing step. Preferably, the water used in these steps of the method is devoid of potassium.

In one embodiment, the thawing step takes place in a freeze dryer. Optionally, at least part of the freezing step takes place in a freeze dryer.

Advantageously, the freezing step is carried out at a temperature of up to −40° C.

Advantageously, the thawing of the biotite takes place at around 1 mbar, as well as optionally part of the freezing step.

Preferably, at least parts of the freezing and thawing steps are carried out under a pressure of approximately 1 mbar.

Advantageously, the thawing step lasts from 36 to 76 hours, preferably from 41 to 66 hours, even more preferably from 46 to 50 hours, and even more preferably 48 hours, during which the temperatures of the biotite and of the water are gradually raised to a temperature ranging from 18 to 25° C., preferably from 19 to 23° C., and even more preferably 20° C., under a pressure of approximately 1 mbar.

Preferably, the gradual rise in temperature comprises the following stages, following one another in this order:
6 hours at −40° C.,
10 hours at −30° C.,
10 hours at −20° C.,
10 hours at −10° C.,
12 hours at +20° C.

Advantageously, the method comprises a step subsequent to the thawing step, during which the temperatures of the biotite and the aqueous solution are gradually raised to a temperature of approximately 30° C., under a pressure of approximately 0.001 mbar, said step lasting from 25 to 65 hours, preferably from 35 to 55 hours, and even more preferably 46 hours.

Preferably, the method for extracting a mineral further comprises a step of releasing the minerals contained in the biotite, in particular in the cleavages of the biotite, preferably by subjecting the biotite to vibrations large enough to release the minerals. Advantageously, the release of the minerals comprises a step of submission to ultrasound.

The invention also relates to a method for characterizing a paleoalteration, in which at least one mineral is studied that is contained in cleavages of biotite extracted from a felsic rock that is at least partially altered. This method of characterizing a paleoalteration has the advantage of being precise and reliable because it is based on fine, isotopic geochemistry. In addition, it makes it possible to characterize the fluids responsible for the alteration. Furthermore, the study is carried out on easily manipulated crystals, since it is carried out on any small mineral phase, included in the biotite flakes.

Advantageously, the mineral contained in the biotite cleavages is extracted using the extraction method described above.

Preferably, the characterization consists of dating the mineral extracted by means of a ³⁹Ar-⁴⁰Ar analysis.

### DETAILED DESCRIPTION OF THE INVENTION

We will now describe an embodiment of the invention given by way of non-limiting example.

The extraction method was carried out on altered granite samples taken from the Massif Central, the Pyrenees and Brittany. One or more thin section(s) made from each sample were studied using a polarizing optical microscope to determine the presence of ±chloritized biotite containing crystals along their cleavages. The samples comprising potassium feldspars within the chloritized biotite was then subjected to the following protocol.

Preparation of the Raw Rock

When necessary, the raw rock was abraded, i.e. the weathered external parts of the rock were removed using a diamond disc saw, underwater. The cleanest possible rock was thus obtained.

The rock thus abraded was then cut into several pieces measuring 10 cm×10 cm using the diamond disc saw, underwater, to facilitate passage through the crusher. The pieces were then dried in an oven at 38° C. for 12 hours.

The cut rock was then crushed in a jaw crusher.

The crushed samples were then subjected to dry sieving on a stainless steel sieve allowing the passage of fragments measuring less than 500 μm.

Washing of the Sieved Sample

The fragments measuring less than 500 μm, resulting from the crushing, were then washed on a stainless steel sieve, making it possible to eliminate the fragments measuring less than 63 μm, in particular the fines generated by the crushing and the minerals measuring less than 63 μm.

A fraction comprising the fragments greater than or equal to 63 μm and less than 500 μm in size was thus obtained. This fraction was then rinsed several times with demineralized water, using a wash bottle, in the same stainless steel sieve, to have the cleanest possible sample.

Sorting of Biotite by Magnetic Separation

A paramagnetic neodymium magnet was used manually. This made it possible to recover the biotite from the sample and place them in a Petri dish by passing a gloved finger over the magnet to detach them. This magnetic separation method is quite fast and efficient.

Final Stages of Biotite Preparation

The biotite obtained by magnetic separation were placed in a plastic screw bottle, in 4 to 5 centimeters of demineralized water. The bottle was then inserted into an ultrasonic tank filled with water, which was kept in operation for 1 hour. This manipulation made it possible to detach any minerals that might be attached to the biotite.

The excess water in the bottle was then removed and the biotite was recovered by loosening it using demineralized water administered via a wash bottle.

Extraction of Minerals Contained in Biotite Cleavages

The mineral extraction protocol according to the invention was then implemented.

In this exemplary embodiment of the invention, the biotite was introduced into a Pyrex beaker with a capacity of 100 ml, containing 1 to 2 centimeters of demineralized water and covered with a non-watertight watch glass-type cover placed over it.

This beaker was then placed in a freezer at a temperature of −32° C. for 12 hours, so that the water in the beaker was frozen.

The beaker containing the biotite was then removed from the freezer and placed in a Christ brand freeze dryer with a heating plate, previously programmed in the freezing phase at −40° C. to keep the beaker frozen. The lyophilization was carried out under temperature and pressure conditions described below, making it possible to sublimate the water:

The beaker containing the biotite was placed in the freeze dryer for 88 hours. The inventors have created a specific lyophilization program.

The first stage of the program, called primary desiccation, lasted 48 hours, during which there was a gradual warming of the plateau from −40° C. to +20° C., under a pressure of 1 mbar. More specifically, the biotite was placed:
6 hours at −40° C., then
10 hours at −30° C., then
10 hours at −20° C., then
10 hours at −10° C., then
12 hours at +20° C.

The mineral extraction method contained in the biotite cleavages therefore comprises a step of freezing the biotite, followed by a step of thawing the biotite. In this method, the biotite was brought into contact with water, prior to the freezing and thawing steps, and was kept in contact with water during the freezing step and part of the thawing step.

Surprisingly, the flakes constituting the biotite was thus opened.

Recovery of Minerals Contained in Biotite Cleavages

The second stage of the program, called secondary drying, lasted 46 hours, during which the plate gradually warmed up to +30° C. under a pressure of 0.001 mbar. More specifically, the biotite was placed for 11 hours at +20° C., then for 35 hours at +30° C.

After breaking the vacuum, the lyophilized material was again subjected to ultrasound in demineralized water, under the conditions described above, in order to release the minerals (potassium feldspars and other minerals) from the biotite flakes, by vibration.

The lyophilized material was then washed and sieved under demineralized water, using a wash bottle, in a stainless steel sieve making it possible to remove elements measuring less than 25 μm, for example clays, which were contained in the biotite and were released during lyophilization.

The lyophilized material was then placed in a Petri dish and was dried in an oven at 38° C. for 24 hours.

Crystals of potassium feldspar were then collected by “picking” using binoculars and a thin steel needle with handle, then placed in a 2 ml plastic mini-tube with funnel bottom. A drop of demineralized water had been placed beforehand at the bottom of the mini-tube to facilitate the detachment of the crystals from the steel needle. The tube was then dried in a conventional oven at 38° C. for a period, allowing complete drying (a few hours).

The potassium feldspar crystals thus extracted are intended to be studied in order to characterize the paleoalteration of the host rock. The characterization may consist of dating by ³⁹Ar-⁴⁰Ar analysis.

The invention is not limited to the embodiments described here, and other embodiments will become clearly apparent to a person skilled in the art. It is in particular possible to implement the extraction method on rocks taken from other massifs. The method can be applied to any type of rock comprising chloritized biotite. The steps of preparing the raw rock and washing the sample can be carried out by any technique known to those skilled in the art, in order to obtain a fraction of fragments of size less than or equal to 1000 μm and greater than or equal to 50 μm, preferably between 60 μm and 500 μm, having the degree of cleanliness that is deemed necessary for the implementation of the following stages of the method. Similarly, the separation of biotite can be carried out by any technique known to those skilled in the art. Finally, the detachment of the minerals still attached to the biotite can be carried out by any technique known in the field. The purpose of these different preparation stages is to obtain biotite not “contaminated” by impurities or minerals not covered by the extraction protocol.

With regard to the implementation of the protocol according to the invention, the containers, freezers and freeze dryers are only given by way of illustration. Any material allowing the biotite to be placed under the temperature and pressure conditions, at the indicated times, may be used.

After opening the biotite flakes, the release of the minerals contained in the biotite flakes can be carried out using any technique capable of subjecting the biotite to vibrations large enough to release the minerals. “Contained in biotite flakes” means “contained in biotite cleavages.”

1. A method for extracting a mineral contained in biotite, characterized in that the method comprises a step of freezing the biotite, followed by a step of thawing the biotite.

2. The method for extracting a mineral according to claim 1, wherein biotite is used in which the mineral is contained in cleavages of the biotite.

3. The method for extracting a mineral according to claim 1, wherein the mineral is chosen from the following minerals: potassium feldspar, quartz, plagioclase and prehnite.

4. The method for extracting a mineral according to claim 1, wherein the biotite is brought into contact with water prior to the freezing and thawing steps, and are kept in contact with water during the freezing step and at least part of the thawing step.

5. The method for extracting a mineral according to claim 1, wherein the thawing step takes place in a freeze dryer.

6. The method for extracting a mineral according to claim 1, wherein the freezing step is carried out at a temperature of up to −40° C.

7. The method for extracting a mineral according to claim 1, wherein the thawing of the biotite takes place at approximately 1 mbar.

8. The method for extracting a mineral according to claim 7, wherein at least part of the freezing step is carried out under a pressure of approximately 1 mbar.

9. A method for extracting a mineral according to claim 4, wherein the thawing step lasts from 36 to 76 hours during which the temperatures of the biotite and of the water are gradually raised to a temperature ranging from 18 to 25° C. under a pressure of approximately 1 mbar.

10. The method for extracting a mineral according to claim 9, wherein the gradual rise in temperature comprises the following stages, following one another in this order:
6 hours at −40° C.,
10 hours at −30° C.,
10 hours at −20° C.,
10 hours at −10° C.,
12 hours at +20° C.

11. The method for extracting a mineral according to claim 10, comprising a step subsequent to the thawing step, during which the temperatures of the biotite and the water are gradually raised to a temperature of approximately 30° C., under a pressure of approximately 0.001 mbar, said step lasting from 25 to 65 hours.

12. The method for extracting a mineral according to claim 1, wherein the thawing of the biotite is a lyophilization.

13. The method for extracting a mineral according to claim 1, further comprising a step of releasing the minerals contained in the biotite by subjecting the biotite to vibrations large enough to release the minerals.

14. A method for characterizing a paleoalteration, characterized in that at least one mineral is studied that is contained in cleavages of biotite extracted from an at least partially altered felsic rock, in which method the mineral contained in cleavages of biotite is extracted using the extraction method according to claim 1, and the characterization of the paleoalteration is carried out by studying the extracted mineral.

15. The characterization method according to claim 14, wherein the characterization consists of dating the mineral extracted by means of a ³⁹Ar-⁴⁰Ar analysis.

16. The method for extracting a mineral according to claim 9, wherein the thawing step lasts from 41 to 66 hours.

17. The method for extracting a mineral according to claim 9, wherein the thawing step lasts from 46 to 50 hours.

18. The method for extracting a mineral according to claim 9, wherein the temperatures of the biotite and of the water are gradually raised to a temperature ranging from 19 to 23° C.

19. The method for extracting a mineral according to claim 11, wherein the step subsequent to the thawing step lasts from 35 to 55 hours.

20. The method for extracting a mineral according to claim 13, wherein the step of releasing the minerals contained in the biotite comprises releasing the minerals in the cleavages of the biotite.
